(19) United States
(12) Patent Application Publication
(10) Pub. No.: US 2013/0253752 A1
(43) Pub. Date: Sep. 26, 2013

(54) CONTINUOUS-MOVE IRRIGATION CONTROL SYSTEM

(71) Applicant: John Paul Grabow, Fort Calhoun, NE (US)

(72) Inventor: John Paul Grabow, Fort Calhoun, NE (US)

(73) Assignee: Lindsay Corporation, Omaha, NE (US)

(21) Appl. No.: 13/428,909

(22) Filed: Mar. 23, 2012

(51) Int. Cl. G05D 1/02

(52) U.S. Cl. 701/25

(57) ABSTRACT

A control system of an irrigation system to continuously drive a plurality of towers supporting an elevated pipeline along a path while maintaining the pipeline in an aligned configuration. The system includes an antenna, a receiver, a controller, and a variable-speed drive motor. The antenna receives signals from at least one external positional information source. The receiver is in communication with the antenna and operable to process the signals to produce positional data corresponding to an alignment of the elevated pipeline. The controller is in communication with the receiver and programmed to adjust a speed of the motor based on the alignment data.

### BACKGROUND

1. Field

Embodiments of the present invention relate to control systems for irrigation systems. More particularly, embodiments of the present invention relate to control systems to guide irrigation systems with elevated irrigation pipelines in a continuous manner while maintaining the pipelines in an aligned configuration.

2. Discussion of Related Art

Crops are cultivated throughout the world in a wide variety of climates with different terrains and soils. It is desirable in many of these climates to artificially supplement the climate's natural precipitation via irrigation systems to ensure crops receive adequate water. Additionally, irrigation systems can be used to deliver fertilizers and chemicals to, among other things, promote healthy crop growth, suppress weeds, and protect crops from frost.

Common irrigation systems include center-pivot systems and lateral-move systems, each having an elevated, elongated pipe supported by a plurality of drive towers spaced along the pipe. The pipe includes a plurality of spaced sprinklers that may extend downward toward the crops to enable distribution of water to the crops from above. Center-pivot systems are ideal for use in fields having circular crop areas and generally include a hydrant located in the middle of each circular crop area. In such systems, an elevated, elongated pipe with sprinklers extends from a hydrant to an outer circumference of the circular crop area such that the systems may be driven in a generally circular or semi-circular pattern over the crops to deliver water thereto during rotation. Lateral-move systems are ideal for use in square, rectangular, and irregular-shaped fields. Such systems generally include one or more hydrants located in and/or adjacent to a field and/or one or more ditches located along or through a field that are connected to an elevated, elongated pipe with sprinklers. Unlike the center-pivot system having a pipe with a stationary end, the pipe in a lateral-move system is connected to and extends from a movable cart designed to traverse up and down a cart path. The pipe may be locked at an angle perpendicular to the cart path and pivot at an end at the cart path, which is desirable if the cart path extends down the middle of a field to enable pivoting from one side of the cart path to the other with each pass along the cart path.

In both center-pivot and lateral-pivot move systems, each pipe is long, for example, twenty to thirty feet, and heavy, given the length of the pipe, the components mounted to the pipe, and the water carried in the pipe. To move the pipe and the drive towers during an irrigation operation, each of the drive towers includes one or more wheels that are fixed in orientation and driven by a mechanical drive unit. The mechanical drive units may be a series of electric motors or other similar sources of propulsion. In general, the mechanical drive units propel the drive towers and the pipe forward, for example, in a circular or lateral pattern along a field and over crops, to provide crop irrigation.

While the pipe and the drive towers are being driven, it is generally desirable to maintain the towers in linear alignment to ensure uniform crop irrigation and prevent kinking or bursting of the pipe if one or more of the drive towers become misaligned.

### SUMMARY

The following brief summary is provided to indicate the nature of the subject matter disclosed herein. While certain aspects of the present invention are described below, the summary is not intended to limit the scope of the present invention. Embodiments of the present invention provide an irrigation control system and method that maintains proper alignment of an elevated, irrigation pipeline and its drive towers, thereby ensuring uniform irrigation of crops and decreasing a likelihood of kinking or bursting of the pipeline. The present invention provides, in its simplest form, an irrigation control system and method to drive at least one drive tower supporting an irrigation pipeline.

The aforementioned aspects may be achieved in one aspect of the present invention by providing a control system to guide a plurality of towers that support a linear pipeline of an irrigation system in a continuous manner along a path. The control system may include an antenna coupled to the linear pipeline, a receiver in communication with the antenna, and/or a controller in communication with the receiver.

The antenna may be operable to receive signals from at least one external positional information source. The receiver may be operable to process the signals to produce position data corresponding to a current position of the drive tower with respect to the support tower and produce alignment data of the drive tower with respect to the support tower. The controller may be programmed to drive the wheel at a speed corresponding to a difference between the current position of the support tower and a point along the path and adjust the speed of the wheel based on the alignment data.

The external positional information source may be a fixed GPS unit. The controller may include a variable-speed drive motor coupled to the drive tower and operable to drive the wheel of the drive tower at variable speeds. The variable-speed drive motor may drive the wheel continuously throughout an irrigation operation and may be operable to perform a correction during the irrigation operation without ceasing movement of the wheel. The controller may be further programmed to generate a control signal to increase or decrease the speed of the wheel if the alignment data is outside of a range of values.

The control signal may maintain a current speed of the wheel if the alignment data indicates that the drive tower is aligned with a vertical plane defined by the end support tower, increase the speed of the wheel if the alignment data indicates that the drive tower is trailing the vertical plane with respect to a forward direction of movement of the drive tower, and/or decrease the speed of the wheel if the alignment data indicates that the drive tower is leading the vertical plane with respect to the forward direction of movement of the drive tower. The controller may be further programmed to transmit a signal to the variable-speed drive motor for adjusting the position of the drive tower with respect to the vertical plane. The controller may be further programmed to generate a control signal to increase or decrease the speed of the wheel if the alignment data is outside of a range of values.

The antenna may be further operable to receive global positioning system information. The control may be further programmed to generate a control signal to activate or deactivate an irrigation nozzle mounted on the drive tower. The global positioning system correction information may be a real time kinematic correction factor. The vertical plane may be aligned with a center of a drive line for the linear pipeline. The linear pipeline may be an elevated irrigation pipeline.

The aforementioned aspects may also be achieved in an aspect of the present invention by providing a tower to transport a portion of an irrigation system along a path. The tower may include a frame having a wheel, a variable-speed drive motor coupled to the wheel, a portion of an overhead irrigation pipeline supported by the frame, an antenna coupled to the frame and vertically aligned with the portion of the overhead irrigation pipeline, a receiver in communication with the antenna, and a controller in communication with the receiver and the variable-speed drive motor.

The variable-speed drive motor may be operable to drive the wheel continuously and at variable speeds to perform correction operations. The antenna may be operable to receive signals from at least one external positional information source. The receiver may be operable to process the signals to produce position data corresponding to a current position of the frame and/or produce alignment data of the frame. The controller may be programmed to drive the wheel at a speed corresponding to a difference between the current position of the frame and a point along the path and/or adjust the speed of the wheel based on the alignment data. The portion of the overhead irrigation pipeline may be positioned at a right angle with respect to a central vertical plane through the wheel.

The controller may be further programmed to transmit a control signal to the variable-speed drive motor so that the speed of the wheel is increased or decreased if the alignment data is outside of a range of values, or maintained if the alignment data is within the range of values. The control signal may increase the speed of the wheel if the alignment data is less than a value and decreases the speed of the wheel if the alignment is greater than the value. The antenna may be further operable to receive a real time kinematic correction factor. The tower may further include an irrigation nozzle coupled to the tower and operable to be activated by the controller based on the position data.

The aforementioned aspects may also be achieved in an aspect of the present invention by providing a method of driving a tower with an elevated pipeline of an irrigation system in a continuous manner along a path while maintaining alignment of the elevated pipeline. The method may include the steps of acquiring a current position of the tower along the path, acquiring alignment data related to the tower and a portion of the irrigation pipeline coupled to the tower, calculating a point along the path that is a distance from the current position, generating a control signal based on the alignment data and the calculated point along the path, transmitting the control signal to a variable-speed drive motor, driving a wheel coupled to the tower via the variable-speed drive motor to cause the tower to continuously move toward the point at a rate that maintains the alignment data within a range of values, and increasing the rate if the alignment data is less than a value within the range of values, or decreasing the rate if the alignment data is greater than the value or another value within the range of values. The method may further include the step of activating an irrigation nozzle on the tower based on the current position of the tower along the path.

Additional aspects, advantages, and utilities of the present invention will be set forth in part in the description which follows and, in part, will be obvious from the description, or may be learned by practice of the present invention.

### BRIEF DESCRIPTION OF THE DRAWINGS

Embodiments of the present invention are described in detail below with reference to the attached drawing figures, wherein:

FIG. 1 is a perspective view of a guidance control system constructed in accordance with various embodiments of the present invention illustrating a lateral move irrigation system with a plurality of drive towers supporting an overhead irrigation pipeline;

FIG. 2 is a top plan view of the guidance control system of FIG. 1, illustrating one of the drive towers leading a horizontal plane defined by the guidance control system; and

FIG. 3 is a flow chart of the guidance control system of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

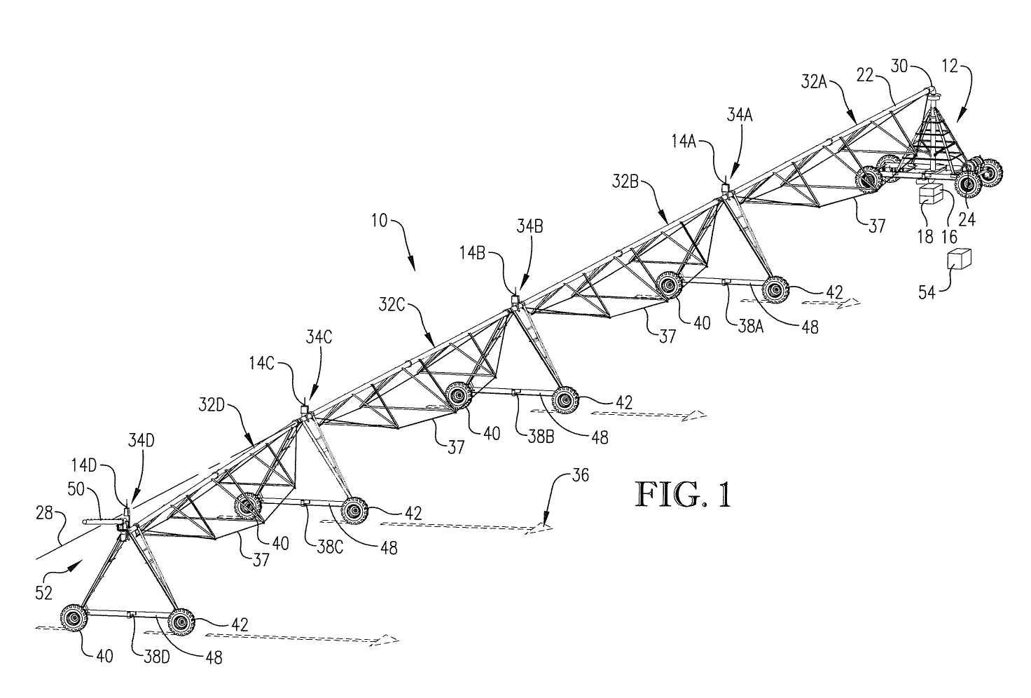

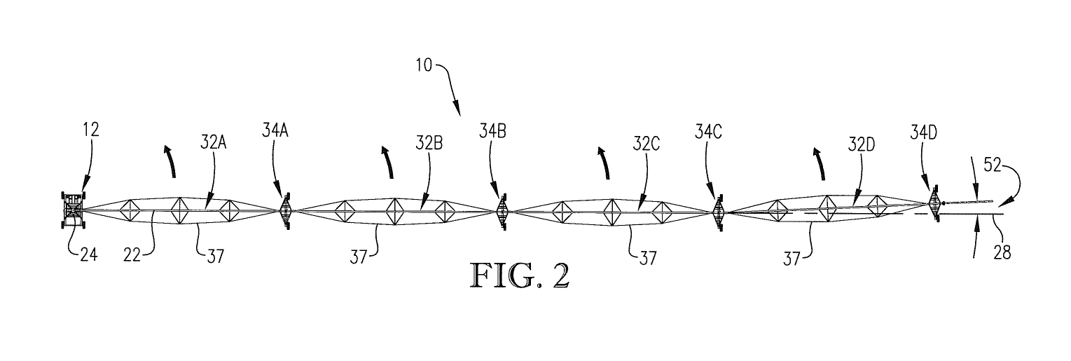

Turning to FIGS. 1 and 2, a guidance control system 10 constructed in accordance with various embodiments of the present invention for use with a portion of an irrigation system 12 is illustrated. An example of a complete irrigation system is shown and described in more detail in U.S. patent application Ser. No. 13/042,192 filed Mar. 7, 2011, which is hereby incorporated into the present application by reference in its entirety. The guidance control system 10 broadly includes a plurality of antennas 14A, 14B, 14C, 14D, a receiver 16, and a controller 18.

The irrigation system 12 is generally utilized to irrigate crops or other farmland areas and includes an elevated linear pipeline 22 extending from a lateral-move cart with support tower 24 that connects the pipeline 22 to a fluid source. The fluid source may be a tank, a well, a canal, or a similar source that typically has a fixed location proximate to or remote from the pipeline 22. The system 10 is illustrated with the lateral-move cart with support tower 24 for illustrative purposes only and may be configured with other types of supports without deviating from the scope of the present invention. For example, the irrigation system 12 may be configured with a stationary center-pivot support tower instead of the lateral-move cart with support tower 24. An example of a lateral-move cart is shown and described in more detail in U.S. Patent Publication No. 2010/0274398 filed Apr. 28, 2009, which is hereby incorporated into the present application by reference in its entirety.

The pipeline 22 extends along a centerline vertical axis 28 when the pipeline 22 is in a perfectly straight configuration. The vertical axis 28 is defined by an elbow joint 30 of the lateral-move cart with support tower 24. The pipeline 22 includes a plurality of fluid-spraying sprinklers affixed to the pipeline 22 along a length thereof to deliver fluid to crops during an irrigation operation. The elbow joint 30 rotatably couples the pipeline 22 to the lateral-move cart with support tower 24. The pipeline 22 has a plurality of sections 32A, 32B, 32C, 32D extending from and connected in series to the elbow joint 30. Although the pipeline 22 is illustrated with four sections 32A, 32B, 32C, 32D, the pipeline 22 may have any number of sections 32A, 32B, 32C, 32D without deviating from the scope of the present invention and preferably has at least two sections, for example, a support-tower joining section, such as section 32A, and an end section such as section 32D.

The sections 32A, 32B, 32C, 32D of the pipeline 22 are substantially identical to each other and respectively include moveable drive towers 34A, 34B, 34C, 34D that cooperatively support the sections 32A, 32B, 32C, 32D in an elevated position. Each of the drive towers 34A, 34B, 34C, 34D includes a structural framework 37 to increase the structural integrity of the sections 32A, 32B, 32C, 32D, a mechanical drive unit 38, and a wheel and tire assembly 40, 42 on either end of the drive unit 38. The drive towers 34A, 34B, 34C, 34D are operable to independently drive the sections 32A, 32B, 32C, 32D laterally and along a path 36 in coordination with the lateral-move cart with support tower 24, which also travels laterally and along the path 36. The drive towers 34A, 34B, 34C, 34D are also operable to independently drive the sections 32A, 32B, 32C, 32D around the lateral-move cart with support tower 24, for instance, to allow the sections 32A, 32B, 32C, 32D to travel around a circular portion at an end of the path 36 and/or to an opposite side of the path 36.

Each of the drive units 38 is mounted to a lateral bar 48 of the drive towers 34A, 34B, 34C, 34D that extends substantially perpendicular to the vertical axis 28, and includes an electric variable-frequency drive VFD motor operable to drive the plurality of wheel and tire assemblies 38, 40 at variable speeds. The drive units 38 are each operable to independently communicate with the controller 18 of the guidance control system 10 so that the controller 18 is operable to independently control each of the drive units 38. The drive units 38 may include linkages, gears, gear boxes, batteries, and other components and communication equipment to allow the wheel and tire assemblies 40, 42 to be driven or rotated in forward and reverse directions along the path 36 as controlled by the controller 18.

The wheel and tire assemblies 40, 42 are mounted to and spaced from each other along the lateral bar 48 in a fixed orientation to generally define a direction of travel of the wheel and tire assemblies 40, 42 along the path 36. The drive units 38 and the wheel and tire assemblies 40, 42 cooperatively permit independent movement of each of the drive towers 34A, 34B, 34C, 34D along the path 36 at equal or variable speeds relative to each other, as determined by the controller 18.

Each one of the plurality of antennas 14A, 14B, 14C, 14D of the guidance control system 10 is rigidly coupled to one section 32A, 32B, 32C, 32D along the pipeline 22. When the pipeline 22 is in the straight configuration, the plurality of antennas 14A, 14B, 14C, 14D extend along the vertical axis 28 defined by the elbow joint 30 of the lateral-move cart with support tower 24. It is foreseen, however, that each of the plurality of antennas 14A, 14B, 14C, 14D may be positioned at a known fixed distance offset to the vertical axis 28, for instance, on another part of the irrigation system 12, without deviating from the scope of the present invention.

Each of the plurality of antennas 14A, 14B, 14C, 14D extends in an upward direction that is roughly perpendicular to the path 36. Thus, the longitudinal axis of each of the plurality of antennas 14A, 14B, 14C, 14D always maintains a right angle relative to the direction of travel of the wheel and tire assemblies 40, 42. In the exemplary embodiment, the plurality of antennas 14A, 14B, 14C, 14D cooperatively operate as a network with each of the plurality of antennas 14A, 14B, 14C, 14D corresponding to one of the sections 32A, 32B, 32C, 32D. It is foreseen, however, that the guidance control system 10 may utilize any number of antennas and as few as a single antenna without deviating from the scope of the present invention.

Each of the plurality of antennas 14A, 14B, 14C, 14D is operable to independently receive a signal containing positional information from a GPS source 15, such as the Global Positioning System satellite navigation system, one or more satellite sources, and/or one or more terrestrial sources. The positional information relates to a position of one or more of the plurality of antennas 14A, 14B, 14C, 14D, such as latitude and/or longitude coordinates of one or more of the plurality of antennas 14A, 14B, 14C, 14D as well as heading and altitude information of one or more of the plurality of antennas 14A, 14B, 14C, 14D. The positional information may be received in a continuous, real-time fashion as is typically determined and controlled by the external systems such as the Global Positioning System and an RTK or similar system. Each of the plurality of antennas 14A, 14B, 14C, 14D is operable to communicate the signals to the receiver 16 as they are received. It is foreseen that the guidance control system 10 may operate with as few as one of the plurality of antennas 14A, 14B, 14C, 14D. For example, antennas 14A, 14B may be removed at the sections 32A, 32B without deviating from the scope of the present invention.

Each of the plurality of antennas 14A, 14B, 14C, 14D may also receive another signal from a correction source or secondary fixed GPS unit 54, which provides a Real Time Kinematic (RTK) system with correction information about the positional information received by each of the plurality of antennas 14A, 14B, 14C, 14D to increase the accuracy of the positional information. With the correction information, the position of the pipeline 22 along the path 36 may be determined to within a few centimeters or less. The correction source 54 may be terrestrial-based and may include a dedicated or shared RTK base station plus radios (900 MHz ISM spread spectrum or licensed at approximately 450 MHz) or a public or commercial virtual reference station plus cellular or radio connections, or may be satellite-based such as OmniSTAR® with compatible receiving components. The correction source 54 is located in the path 36 in the exemplary embodiment, but may be located at any known distance that enables communication between the correction source 54 and the antenna 14.

The receiver 16 of the guidance control system 10 is located in a fixed location that is remote from the plurality of antennas 14A, 14B, 14C, 14D. It is foreseen, however, that the receiver 16 may be located anywhere, for example, on the irrigation system 12, provided that the receiver 16 is operable to communicate with the plurality of antennas 14A, 14B, 14C, 14D. The receiver 16 may include crystal oscillators and signal amplifiers as well as other components as are known in the art. The receiver 16 is operable to receive, via a wired or wireless connection, each of the signals from the plurality of antennas 14A, 14B, 14C, 14D and independently output the signals to the controller 18. It is foreseen that the receiver 16 may perform one or more processing operations on signals received. In the exemplary embodiment, the receiver 16 assigns a unique identifier to each of the signals received to enable identification of the source from which each of the signals was received, that is, from which of the plurality of antennas 14A, 14B, 14C, 14D.

The controller 18 of the guidance control system 10 is located in a fixed location that is remote from the plurality of antennas 14A, 14B, 14C, 14D and is preferably adjacently located to the receiver 16 and wired thereto for communication therewith. It is foreseen, however, that the controller 18 may be located anywhere, for example, secured to the irrigation system 12, provided that the controller 18 is operable to communicate with the receiver 16, for instance, via at least a wireless connection.

The controller 18 is operable to receive and further process the information transmitted from the receiver 16 to determine various factors related to each of the plurality of antennas 14A, 14B, 14C, 14D. For instance, the factors determinable by the controller 18 based on the information may be the latitude and/or longitude coordinates of one or more of the plurality of antennas 14A, 14B, 14C, 14D as well as heading and altitude information of one or more of the plurality of antennas 14A, 14B, 14C, 14D. The controller 18 may then compare the factors of each of the plurality of antennas 14A, 14B, 14C, 14D to determine whether the pipeline 22 and/or the drive towers 34A, 34B, 34C, 34D are aligned with each other and/or the vertical axis 28. The factors may be determined by the controller 18 in a continuous, real-time fashion as the information is transmitted by the receiver 16 and the plurality of antennas 14A, 14B, 14C, 14D. The controller 18 is further operable to control the speed of the pipeline 22 and drive towers 34A, 34B, 34C, 34D as they travel along the path 36 based on one or more of the signals. For instance, the controller 18 may set a speed of each of the drive units 38A, 38B, 38C, 38D to an equal and/or different speeds relative to each other. In the exemplary embodiment, the controller 18 utilizes speeds for each of the drive units 38A, 38B, 38C, 38D that are slightly different to account for a radial distance of the drive units 38A, 38B, 38C, 38D from the lateral-move cart with support tower 24.

The controller 18 is operable to individually communicate with the drive units 38A, 38B, 38C, 38D by transmitting control signals of varying frequencies that are receivable by the drive units 38A, 38B, 38C, 38D. The drive units 38A, 38B, 38C, 38D are each assigned to one or more different frequencies, which, when received by one or more of the drive units 38A, 38B, 38C, 38D, cause the drive unit 38A, 38B, 38C, 38D to perform a function. For example, a control signal transmitted by the controller 18 may cause one or more of the drive units 38A, 38B, 38C, 38D to increase, decrease, and/or maintain its rotational speed of the wheel and tire assemblies 40, 42 based on the current position of the pipeline 22 and drive towers 34A, 34B, 34C, 34D with respect to the vertical axis 28 and the path 36 that the pipeline 22 is supposed to follow.

The controller 18 may include processors, microprocessors, microcontrollers, field-programmable gate arrays (FPGAs), similar programmable logic devices, or combinations thereof. The controller 18 may further include data storage components, or memory, such as random-access memory (RAM), read-only memory (ROM), erasable programmable read-only memory (EPROM), and the like, as well as hard drives, compact disc ROM (CDROM) drives, digital video disc (DVD) drives, flash drives, or the like, and combinations thereof. The controller 18 may also include data input devices, such as keypads, keyboards, mice, etc., and data output devices, such as monitors, displays, lighted indicators, printers, and the like. The controller 18 may additionally include ports to receive data from external sources such as hard wired ports to receive electrical data over a wire or cable, or radio-frequency (RF) ports to receive data wirelessly.

The controller 18 may be configured or programmed to execute instructions or operations which may be implemented in hardware, software, firmware, or combinations thereof. In various embodiments, the instructions may be included in a program which may be stored on a computer-readable medium such as RAM, ROM, EPROM, flash memory, a hard-disk drive, a floppy disk, a CD or CDROM or variations thereof, a DVD, a Blu-ray Disc™ (BD), and the like.

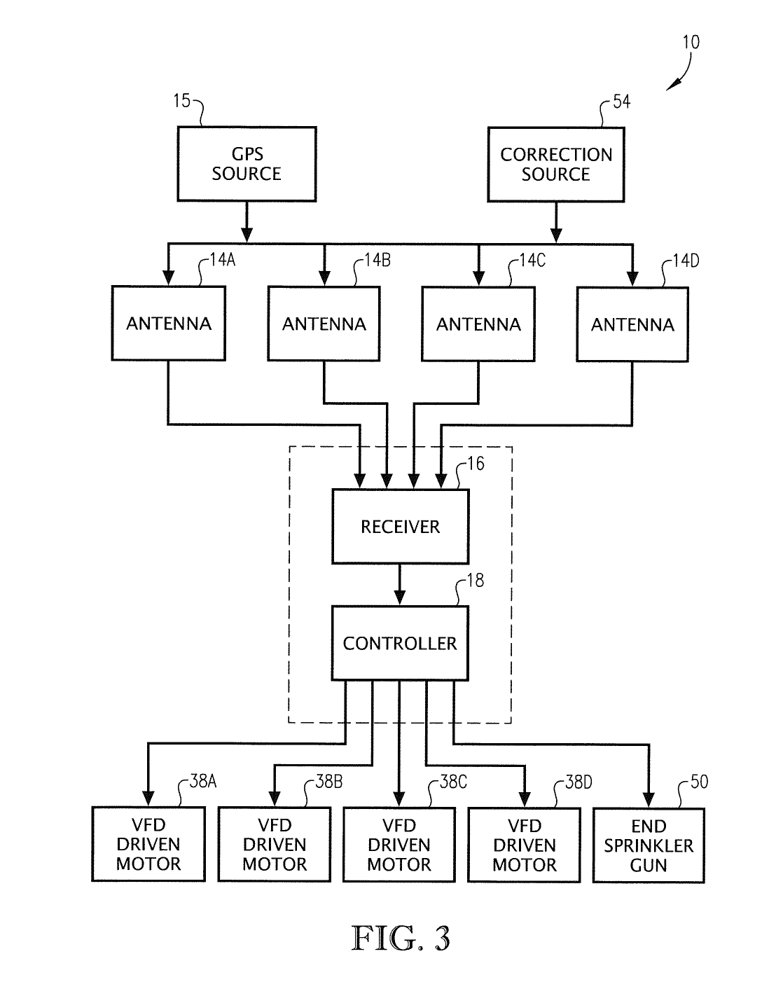

Turning to FIG. 3, the guidance control system 10 may operate as follows. To begin an irrigation operation, the controller 18 transmits control signals at various frequencies to each of the drive units 38A, 38B, 38C, 38D, which initiates movement of the pipeline 22 and drive towers 34A, 34B, 34C, 34D along the path 36 at a predetermined speed. As the drive units 38A, 38B, 38C, 38D and hence the pipeline 22 move along the path 36, each of the plurality of antennas 14A, 14B, 14C, 14D receives the signals from the GPS source 15 and the correction source 54 in a continuous and real-time fashion. The information is transmitted from each of the plurality of antennas 14A, 14B, 14C, 14D to the receiver 16 for processing as the information is received by the plurality of antennas 14A, 14B, 14C, 14D. The receiver 16 assigns a unique identifier to the information to enable identification of the source from which the information was received, that is, from which of the plurality of antennas 14A, 14B, 14C, 14D. The receiver 16 then transmits the information to the controller 18.

The controller 18 processes the information to derive positional, heading, and/or altitude information of each of the plurality of antennas 14A, 14B, 14C, 14D, and assigns a value to each of the plurality of sections 32A, 32B, 32C, 32D based on the information that represents a real-time position of each of the plurality of sections 32A, 32B, 32C, 32D. The controller 18 then compares each value of the plurality of sections 32A, 32B, 32C, 32D to stored data to determine whether each value corresponds to a correct position along the path 36 for each of the plurality of antennas 14A, 14B, 14C, 14D. The correct position of the plurality of antennas 14A, 14B, 14C, 14D corresponds to the vertical axis 28 and, in the exemplary embodiment, is the is the plurality of antennas 14A, 14B, 14C, 14D aligned along and/or within a predetermined acceptable distance or range of the vertical axis 28, for instance, one foot from the vertical axis 28.

In the exemplary embodiment, the correct position is derived based on the speed at which the plurality of sections 32A, 32B, 32C, 32D are traveling, as determined by the controller. In other embodiments, the correct position may be derived based on data stored in the controller 18 about the path 36 that the wheels and tire assemblies 40, 42 should follow. In other embodiments, the correct position may be derived based on information received by the controller 18 about the path 36 from an external source. In other embodiments, the correct position may be derived based on sensory data received by the controller 18 from one or more sensors, for instance, sensory data of a real-time position of the elbow joint 30 and the vertical axis 28.

If the value of one or more of the plurality of sections 32A, 32B, 32C, 32D is not equal to and/or outside of the predetermined acceptable range of the correct position, then one or more of the plurality of sections 32A, 32B, 32C, 32D are misaligned. To correct the misalignment, the controller 18 transmits a control signal to one or more of the drive units 38A, 38B, 38C, 38D to temporarily reduce and/or increase the speed of one or more of the drive towers 34A, 34B, 34C, 34D until the value of one or more of the plurality of sections 32A, 32B, 32C, 32D is equal to and/or within the predetermined acceptable range of the correct position. The control signal may by characterized by, for example, a specific frequency.

For exemplary purposes, FIGS. 1 and 2 illustrate drive tower 34D leading the other drive towers 34A, 34B, 34C and causing the section 32D of the pipeline 22 to bend and extend horizontally beyond of the vertical axis 28, which may result in non-uniform irrigation of crops. If the pipeline 22 bends too far beyond the vertical axis 28, the pipeline 22 may kink or break and require significant maintenance and downtime of the irrigation system 12. To correct the illustrated bend in the pipeline 22, the controller 18, upon a determination by the controller 18 that drive tower 34D is misaligned via the information transmitted from the antenna 14D, transmits a control signal with a specific frequency assigned to drive unit 38D to cause the drive unit 38D to temporarily decrease speed to a new speed that is less than a speed traveled by the drive towers 34A, 34B, 34C. Because the drive unit 38D has the VFD motor, the drive unit 38D is not required to stop to realign the drive tower 34D with the drive towers 34A, 34B, 34C and may make corrections by simply changing speed. Thus, the present invention provides for a relatively smooth realignment of the drive towers 34A, 34B, 34C, 34D via one or more speed adjustments without stopping of the tower 34D, which could result in excessive irrigation of crops under the stopped drive tower 34D.

When the information, as continuously transmitted from the antenna 14D, indicates that the drive tower 34D is aligned with drive towers 34A, 34B, 34C, the controller 18 transmits another control signal assigned to drive unit 38D to cause the drive unit 38D to increase speed to a speed sufficient to maintain alignment of the drive towers 34A, 34B, 34C, 34D. It is foreseen that, due to the nature of the path 36, the drive towers 34A, 34B, 34C, 34D may travel in slightly different speeds to maintain alignment of the drive towers 34A, 34B, 34C, 34D. For example, outermost drive tower 34D may travel faster than innermost drive tower 34A to maintain alignment of the drive towers 34A, 34B, 34C, 34D. In this manner, controller 18 is operable to ensure that the pipeline 22 maintains a straight configuration with the plurality of sections 32A, 32B, 32C, 32D aligned as the pipeline 22 and the drive towers 34A, 34B, 34C, 34D travel along the path 36.

The information provides additional functionality to the guidance control system 10. In the exemplary embodiment, the controller 18 controls operation of an end sprinkler gun 50 mounted to the drive tower 34D at an end 52 of the pipeline 22. The position of the end sprinkler gun 50 on the drive tower 34D at the end of the series of drive towers 34A, 34B, 34C, 34D allows the end sprinkler gun 50 to irrigate one or more portions of the path 36 beyond the end 52 of the pipeline 22. For instance, if irrigation is desired beyond the end 52 of the pipeline 22 and the drive towers 34A, 34B, 34C, 34D, the controller may selectively activate the end sprinkler gun 50 when the information indicates that the end sprinkler gun 50 and the pipeline 22 are in a position to irrigate and deactivate the end sprinkler gun 50 and the pipeline 22 have traveled beyond the position. In this manner, the guidance control system 10 is operable to irrigate one or more portions of the path 36 beyond the end 52 of the pipeline 22.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A control system to guide an irrigation system drive tower carrying a linear pipeline in a continuous manner along a path, the control system comprising:
an antenna coupled to the linear pipeline and operable to receive signals from at least one external positional information source;
a receiver in communication with the antenna, the receiver operable to (i) process the signals to produce position data corresponding to a current position of the drive tower with respect to a support tower, and (ii) produce alignment data of the drive tower with respect to the support tower; and
a controller in communication with the receiver, the controller programmed to (i) drive a wheel of the drive tower at a speed corresponding to a difference between the current position of the support tower and a point along the path, and (ii) adjust the speed of the wheel based on the alignment data.

2. The control system of claim 1, wherein the at least one external positional information source is a fixed GPS unit.

3. The control system of claim 1, wherein the controller includes a variable-speed drive motor coupled to the drive tower and operable to drive the wheel of the drive tower at variable speeds.

4. The control system of claim 1, wherein the variable-speed drive motor drives the wheel continuously throughout an irrigation operation and does not cease movement of the wheel to perform a correction during the irrigation operation.

5. The control system of claim 1, wherein the controller is further programmed to generate a control signal to increase or decrease the speed of the wheel if the alignment data is outside of a range of values.

6. The control system of claim 5, wherein the control signal (i) maintains a current speed of the wheel if the alignment data indicates that the drive tower is aligned with a vertical plane defined by the end support tower, (ii) increases the speed of the wheel if the alignment data indicates that the drive tower is trailing the vertical plane with respect to a forward direction of movement of the drive tower, and (iii) decreases the speed of the wheel if the alignment data indicates that the drive tower is leading the vertical plane with respect to the forward direction of movement of the drive tower.

7. The control system of claim 4, wherein the controller is further programmed to transmit a signal to the variable-speed drive motor for adjusting the position of the drive tower with respect to a vertical plane defined by the end support tower.

8. The control system of claim 1, wherein the controller is further programmed to generate a control signal to increase or decrease the speed of the wheel if the alignment data is outside of a range of values.

9. The control system of claim 1, wherein the antenna is further operable to receive global positioning system information.

10. The control system of claim 1, wherein the controller is further programmed to generate a control signal to activate or deactivate an irrigation nozzle mounted on the drive tower.

11. The control system of claim 10, wherein the global positioning system correction information is a real time kinematic correction factor.

12. The control system of claim 1, wherein a vertical plane defined by the end support tower is aligned with a center of a drive line for the linear pipeline.

13. The control system of claim 12, wherein the linear pipeline is an elevated irrigation pipeline.

14. A tower to transport a portion of an irrigation system along a path, the tower comprising:
a frame having a wheel;
a variable-speed drive motor coupled with the wheel and operable to drive the wheel continuously and at variable speeds to perform correction operations;
a portion of an overhead irrigation pipeline supported by the frame and positioned at a right angle with respect to a central vertical plane through the wheel;
an antenna coupled to the frame and vertically aligned with the portion of the overhead irrigation pipeline, the antenna operable to receive signals from at least one external positional information source;
a receiver in communication with the antenna, the receiver operable to (i) process the signals to produce position data corresponding to a current position of the frame, and (ii) produce alignment data of the frame; and
a controller in communication with the receiver and the variable-speed drive motor, the controller programmed to (i) drive the wheel at a speed corresponding to a difference between the current position of the frame and a point along the path, and (ii) adjust the speed of the wheel based on the alignment data.

15. The tower of claim 14, wherein the controller is further programmed to transmit a control signal to the variable-speed drive motor so that the speed of the wheel is (i) increased or decreased if the alignment data is outside of a range of values, or (ii) maintained if the alignment data is within the range of values.

16. The tower of claim 15, wherein the control signal increases the speed of the wheel if the alignment data is less than a value and decreases the speed of the wheel if the alignment is greater than the value.

17. The tower of claim 14, wherein the antenna is further operable to receive a real time kinematic correction factor.

18. The tower of claim 14, further comprising:
an irrigation nozzle coupled to the tower and operable to be activated by the controller based on the position data.

19. A method of driving a tower with an elevated pipeline of an irrigation system in a continuous manner along a path while maintaining alignment of the elevated pipeline, the method comprising the steps of:
acquiring a current position of the tower along the path;
acquiring alignment data related to the tower and a portion of the irrigation pipeline coupled to the tower;
calculating a point along the path that is a distance from the current position;
generating a control signal based on the alignment data and the calculated point along the path;
transmitting the control signal to a variable-speed drive motor;
driving a wheel coupled to the tower via the variable-speed drive motor to cause the tower to continuously move toward the point at a rate that maintains the alignment data within a range of values; and
increasing the rate if the alignment data is less than a value within the range of values, or decreasing the rate if the alignment data is greater than the value or another value within the range of values.

20. The method of claim 19, further comprising the step of:
activating an irrigation nozzle on the tower based on the current position of the tower along the path.
